(19) United States
(12) Patent Application Publication
(10) Pub. No.: US 2003/0076675 A1
(43) Pub. Date: Apr. 24, 2003

(54) Sunshine curtain

(76) Inventor: Kai Lu, Corvallis, OR (US)

Correspondence Address: Kai Lu, 3806 NW Jameson Dr., Corvallis, OR, 97330, US

(21) Appl. No.: 09/978,505

(22) Filed: Oct. 18, 2001

(51) Int. Cl. F21S 4/00; F21S 8/00

(52) U.S. Cl. 362/145; 362/151; 362/217

(57) ABSTRACT

A sunshine curtain is a closed cubicle formed by a mounting base, a front wall, a back wall, two sidewalls and a bottom. There is a light tube inside the cubicle. On the outside of the front wall, there is a drawing of a normal window picture. On the inside of the back wall, there is a drawing of a sunshine-outside picture. The part of the front wall, which is covered by the glass area of the window picture on the outside of the front wall, is made of transparent material, so that we can see the sunshine-outside picture on the inside of the back wall through the front wall as if we saw the sunshine outside through the window. When the light tube inside the sunshine curtain is on, the light will come out of the sunshine curtain through the transparent area of the front wall. It looks like the sunlight comes in the room through the window. Therefore, the sunshine effect is created even when it's cloudy outside. The sunshine curtain can help people to overcome the depression caused by long-time rain or cloudy weather. It is also a beautiful decoration and entertainment item for a room.

A variation of this invention is called sunshine ceiling. It can also create the sunshine effect when it's cloudy outside.

### BACKGROUND

1. Field of Invention

This invention relates generally to curtains, and more particularly to decoration curtains.

2. Discussion of Prior Art

Curtains can be found in almost every room. Curtains are mainly used for blocking sunlight from coming into the room or preventing others from looking into the room. And curtains are also decoration items for a room. But none of the existing curtains create a sunshine effect when it's cloudy outside.

There are three U.S. patents related to curtains and decoration: U.S. Pat. No. 6,241,552, Connecting structure type (III) of electrical wires and bulb units of a decorative lighting net, issued Jun. 5, 2001, this is a connecting structure type (III) of a decorative lighting net includes several electrical wires intercrossed and connected with a plurality of bulb units to become a complete net or a curtain-type decoration; U.S. Pat. No. 6,112,442, Structure of a gift box with amazing effects, issued Sep. 5, 2000, this is a gift box includes a housing with a lid, the housing having a top formed with an opening, a decoration container arranged within the housing; U.S. Pat. No. 5,412,553, Lighted curtain hardware assembly for windows, issued May 2, 1995, A lighted curtain hardware assembly for a wall having an opening therein has a curtain support hardware device. The hardware device is mountable adjacent the opening, such as a window or door, for supporting a curtain in front of and adjacent the opening without visually obstructing the opening.

There is one U.S. patent related to curtains and sunshine: U.S. Pat. No. 5,566,471, Electromotive curtain for drying clothes, issued Oct. 22, 1996, An electromotive curtain machine for drying clothes using a rain sensor, a sunshine sensor, and a wind sensor which will send existing rain, sun, or wind conditions to a central processing unit so as to control a curtain driving unit. The curtain driving unit will close curtains to protect drying clothes from undesirable weather elements.

All the inventions above try to create either a new kind of curtain structure or a new kind of hardware assembly. None of them try to create a sunshine effect when it's cloudy outside.

### OBJECTS AND ADVANTAGES

Accordingly, the major advantage of this Sunshine Curtain is the creation of a sunshine effect when it's cloudy outside. Therefore, it can be used to help people to overcome the depression caused by long-time rain or cloudy weather. It is also a beautiful decoration and entertainment item for a room.

### DRAWING FIGURES

FIG. 1 shows the front view of a Sunshine Curtain, the basic version of this invention.

FIG. 2 shows the side view of the Sunshine Curtain.

FIG. 3 shows the front view of a Sunshine Ceiling, a variation of this invention.

FIG. 4 shows the side view of the Sunshine Ceiling.

### REFERENCE NUMBERS IN DRAWINGS

| | |
|---|---|
| 10 mounting base | 12 wire |
| 14 light tube | 16 sidewall |
| 18 nontransparent area of front wall | 20 the drawing of window picture |
| 22 transparent area of front wall | 24 bottom |
| 26 front wall | 28 back wall |

### SUMMARY

In accordance with the present invention, a sunshine curtain is provided. The sunshine curtain can create a sunshine effect when it's cloudy outside, so that it can help people to overcome the depression caused by long-time rain or cloudy weather.

In the northwest region of US, usually the cloudy weather starts from October and continues to next May. More than six months of continuous rain or cloudy weather makes people feel depressed. The sunshine curtain of the present invention will create a sunshine effect even when it's cloudy outside. This will help people to feel better and to increase productivity during a long-time rain or cloudy weather.

The present invention is not intended to create a new curtain structure or a new mounting method. The key of this invention is to create the sunshine effect when it is cloudy outside.

The sunshine curtain of the present invention is a closed cubicle formed by a mounting base, a front wall, a back wall, two sidewalls and a bottom. And there is a light tube inside the cubicle. On the outside of the front wall, there is a drawing of a normal window. On the inside of the back wall, there is a drawing of sunshine-outside picture. The part of the front wall, which is covered by the glass area of the drawing on the outside of the front wall, is made of transparent material, so that we can see the inside of the back wall through the front wall. Because there is a sunshine-outside picture on the inside of the back wall, it looks like we see the sunshine outside through the window.

When we turn on the light tube inside the sunshine curtain, the light will come out of the curtain from the transparent area of the front wall. It looks like the sunlight comes in the room from outside. Therefore, the sunshine effect is created.

The mounting base is used for mounting the sunshine curtain on a wall or on a window frame.

A variation of the present invention is a sunshine ceiling. A simple version of the sunshine ceiling is a closed cubicle formed by four mounting bases, a front wall and a back wall. And there are four light tubes inside the cubicle. On the outside of the front wall, there is drawing of a sky window. On the inside of the back wall, there is a drawing of a sunny sky.

The part of the front wall, which is covered by the glass area of the drawing on the outside of the front wall, is made of transparent material. Therefore, we can see the sunny sky picture on the inside of the back wall through the transparent area of the front wall. It looks like we see the sunny sky through the sky window.

When we turn on the light tubes inside the sunshine ceiling, the light will come out of the sunshine ceiling from the transparent area of the front wall. It looks like the sunlight comes in the room from outside. Therefore, the sunshine effect is achieved.

The mounting bases are used for mounting the sunshine ceiling on the walls around the ceiling or on the ceiling.

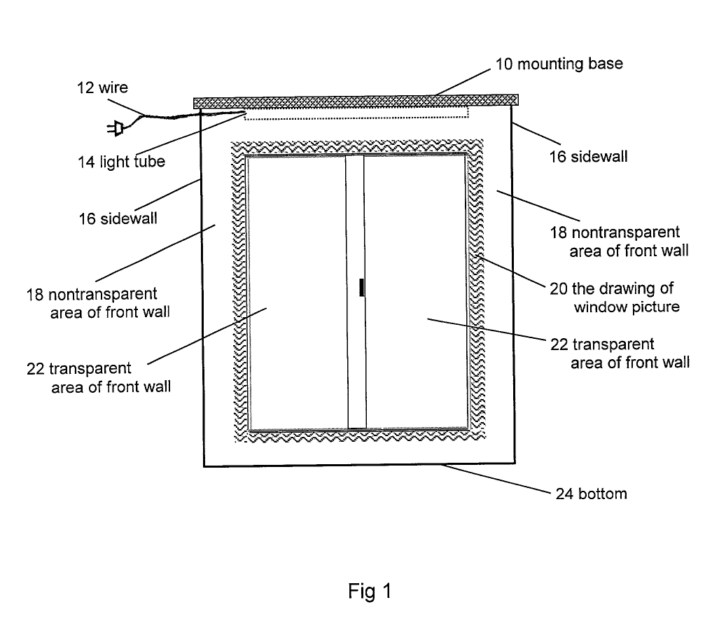

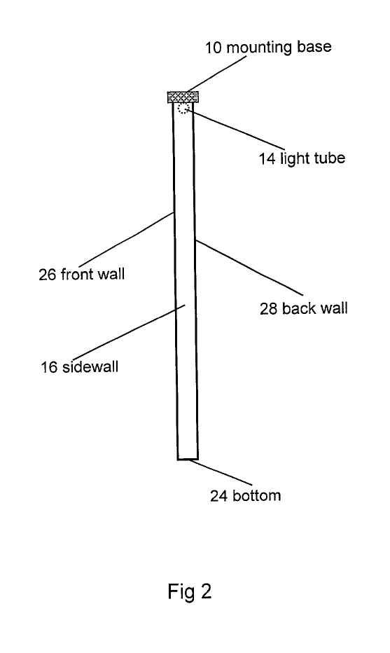

### Description—FIGS. 1 and 2

FIG. 1 shows the front view of a basic version of my widget, the sunshine curtain, and FIG. 2 shows the side view of the sunshine curtain. The sunshine curtain is a closed cubicle formed by a mounting base (FIGS. 1, 10), a front wall (FIGS. 2, 26), a back wall (FIGS. 2, 28) two sidewalls (FIGS. 1, 16), and a bottom (FIGS. 1, 24). There is a light tube (FIGS. 1, 14) inside the cubicle mounted on the mounting base. The space between the front wall and the back wall should be big enough to hold the light tube. The size of the front wall and the back wall depends on the actual window or door we want to cover.

On the outside of the front wall, there is a drawing of a window picture (FIGS. 1, 20). The part of the front wall, which is covered by the glass area of the window picture, is made of transparent material (FIGS. 1, 22). Other parts of the front wall are made of nontransparent material (FIGS. 1, 18). The mounting base, back wall, two sidewalls and the bottom are all made of nontransparent material. On the inside of the back wall, there is a drawing of sunshine-outside picture.

When we turn on the light tube inside the sunshine curtain, the light will come out of the sunshine curtain from the transparent area. It looks like the sunlight comes in the room from outside. And from the transparent area of the front wall we can see the sunshine-outside picture on the inside of the back wall. It looks like we see the sunshine outside through the window. Therefore, we will feel that the outside is sunny.

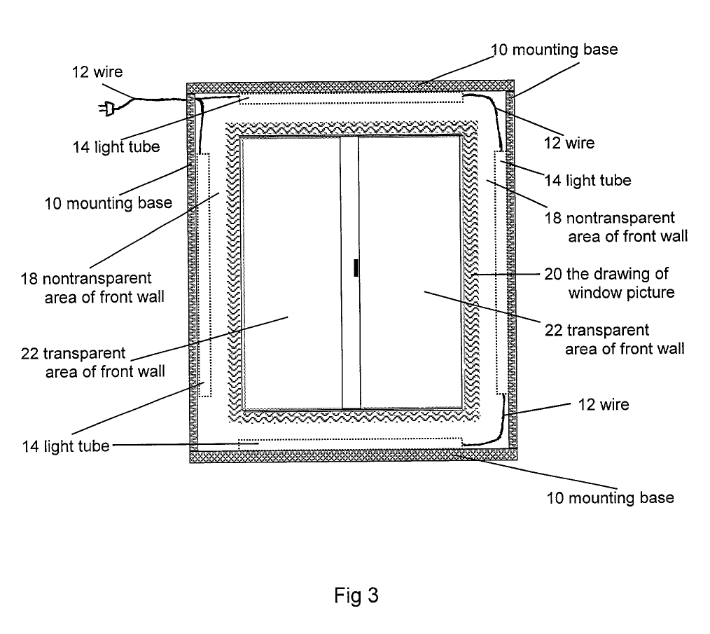

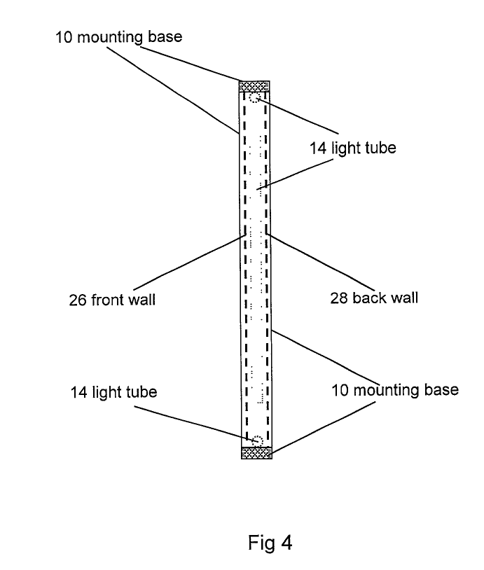

### Description—FIGS. 3 and 4

FIG. 3 shows the front view of a different version of my widget, which can be used as a sunshine ceiling, and FIG. 4 shows the side view of the sunshine ceiling. The sunshine ceiling is a closed cubicle formed by four mounting bases (FIGS. 3, 10), a front wall (FIGS. 4, 26) and a back wall (FIGS. 4, 28). And there are four light tubes (FIGS. 3, 14) inside the cubicle. Each light tube is mounted on one mounting base. The space between the front wall and the back wall should be big enough to hold the light tubes. The size of the front wall and the back wall depends on the actual ceiling we want to cover.

On the outside of the front wall, there is a drawing of a sky-window picture (FIGS. 3, 20). The part of the front wall, which is covered by the glass area of the window picture, is made of transparent material (FIGS. 3, 22). Other parts of the front wall are made of nontransparent material (FIGS. 3, 18). The four mounting bases and the back wall are made of nontransparent material. On the inside of the back wall, there is a drawing of a sunny sky picture.

When we turn on the light tubes inside the sunshine ceiling, the light will come out of the sunshine ceiling from the transparent area. It looks like the sunlight comes in the room from outside. And from the transparent area of the front wall we can see the sunny sky picture on the inside of the back wall. It looks like we see the sunny sky through the sky window. Therefore, we will feel that it's sunny outside.

### Conclusion, Ramifications, and Scope of Invention

Thus, those skilled in the art will appreciate that the sunshine curtain and the sunshine ceiling of the present invention provide the sunshine effect when it's cloudy outside. Therefore, they can help people to overcome the depression caused by long-time rain or cloudy weather. They are also beautiful decoration items for a room.

While my description above contains specificities, these should not be construed as limitations on the scope of the invention but rather as an exemplification of one preferred embodiment thereof. Many other variations are possible. For example, a forest ceiling or a garden curtain can make people feel that they were in a beautiful forest or garden, which has decoration and entertainment functionalities.

Accordingly, the scope of the invention should be determined not by embodiment illustrated, but by the appended claims and their legal equivalents.

I claim

1. A sunshine curtain comprising a mounting base, a front wall, a back wall, two sidewalls, a bottom, and a light source;
A means of forming said mounting base, said front wall, said back wall, said two sidewalls and said bottom into a closed cubicle;
A means for mounting said light source inside the cubicle on said mounting base;
On the outside of said front wall, there is a drawing of a window picture;
On the inside of said back wall, there is a drawing of sunshine-outside picture;
The part of said front wall, which is covered by the glass area of said drawing of a window picture on the outside of said front wall, is made of transparent material, other parts of said front wall are made of nontransparent material;
The said mounting base, said back wall, said sidewalls and said bottom are made of nontransparent material and
a means for mounting said mounting base on a wall or a window frame.

2. The sunshine curtain of claim 1 wherein said front wall whereon said drawing is a picture of a door.

3. The sunshine curtain of claim 1 wherein said front wall whereon said drawing is a picture of a room opening.

4. The sunshine curtain of claim 1 wherein said light source is a light tube.

5. The sunshine curtain of claim 1 wherein said light source is a light bulb.

6. A sunshine ceiling comprising a plurality of mounting bases, a front wall, a back wall and a plurality of light sources;
A means of forming said mounting bases, said front wall and said back wall into a closed cubicle;
A means for mounting said light source inside the cubicle on said mounting base;
On the outside of said front wall, there is a drawing of a sky-window picture;
On the inside of said back wall, there is a drawing of sunny sky picture;
The part of said front wall, which is covered by the glass area of said drawing of a sky-window picture on the outside of said front wall, is made of transparent material, other parts of said front wall are made of nontransparent material;
The said mounting bases and said back wall are made of nontransparent material and
A means for mounting said mounting base on a wall or a ceiling.

7. The sunshine ceiling of claim 6 wherein said front wall whereon said drawing is a picture of a roof opening.

8. The sunshine ceiling of claim 6 wherein said light sources are light tubes.

9. The sunshine ceiling of claim 6 wherein said light sources are light bulbs.
